(19) United States
(12) Patent Application Publication
(10) Pub. No.: US 2025/0234802 A1
(43) Pub. Date: Jul. 24, 2025

(54) LAWNMOWER

(71) Applicant: DREAME TECHNOLOGY (SUZHOU) CO.,LTD., Suzhou (CN)

(72) Inventors: Bin LIU, Suzhou (CN); Ruochu YANG, Suzhou (CN); Jianzhao ZHONG, Suzhou (CN)

(73) Assignee: DREAME TECHNOLOGY (SUZHOU) CO.,LTD., Suzhou (CN)

(21) Appl. No.: 19/033,280

(22) Filed: Jan. 21, 2025

Related U.S. Application Data
(63) Continuation of application No. PCT/CN2024/139386, filed on Dec. 13, 2024.

(30) Foreign Application Priority Data
Dec. 22, 2023 (CN) 202323529824.1

(51) Int. Cl. A01D 34/82; A01D 34/00; A01D 101/00

(52) U.S. Cl. CPC A01D 34/828; A01D 34/008; A01D 2101/00

(57) ABSTRACT

A lawn mower is provided. The lawn mower includes a body, where the body has an output axis; a cutting mechanism, where the cutting mechanism is located below the body and is mounted in cooperation with the output axis, and the cutting mechanism includes a cutter head and a blade mounted on the cutter head; and a protection mechanism, where at least a part of the protection mechanism is located below the cutting mechanism. The protection mechanism includes at least two strip-shaped pieces disposed at intervals, the strip-shaped piece includes a middle portion, the cutter head is located above the middle portion. In this application, the protection mechanism is set to include at least two strip-shaped pieces.

### CROSS-REFERENCE TO RELATED APPLICATIONS

This application is a continuation of PCT/CN2024/139386 filed on Dec. 13, 2024, which claims priority to Chinese Patent Application No. 202323529824.1 filed with the Chinese Patent Office on Dec. 22, 2023 and entitled “LAWN MOWER”, the entire contents of each of which are incorporated herein by reference.

### TECHNICAL FIELD

This application relates to the field of electric tool technologies, and in particular, to a lawn mower.

### BACKGROUND

With the development of automatic technologies and artificial intelligence, an intelligent lawn mower can automatically execute a lawn mowing task, so that people save time greatly and provide great convenience to life.

Due to safety regulations and energy consumption requirements, intelligent lawn mowers in the current market are usually designed with a relatively small-sized cutter head. Consequently, a cutting width is small, and grass at an edge of a lawn cannot be cut. The edge of the lawn needs to be manually trimmed, which reduces an automation degree of the intelligent lawn mower.

In addition, a protection mechanism is disposed on a lawn mower to satisfy requirements of safety regulations. Currently, the protection mechanism has a complex structure and has high production costs.

The information disclosed in the background part is only intended to increase the understanding of the general background of the application, and should not be regarded as an admission or any form of suggestion that the information constitutes the prior art known to those skilled in the art.

### SUMMARY

Embodiments of this application provide a lawn mower, which can simplify a structure of a protection mechanism and reduce costs.

This application provides a lawn mower, where the lawn mower includes: a body, where the body has an output axis;
a cutting mechanism, where the cutting mechanism is located below the body and is mounted in cooperation with the output axis, and the cutting mechanism includes a cutter head and a blade mounted on the cutter head; and
a protection mechanism, where at least a part of the protection mechanism is located below the cutting mechanism.

The protection mechanism includes at least two strip-shaped pieces disposed at intervals, the strip-shaped piece includes a middle portion, the cutter head is located above the middle portion, and a length of the middle portion gradually increases in a direction from an outer side to an inner side of the cutting mechanism.

In this application, the protection mechanism is set to include at least two strip-shaped pieces. The two strip-shaped pieces may simplify a structure of the protection mechanism, facilitate processing and installation, and further reduce costs. In addition, the strip-shaped pieces are disposed at intervals, a gap between the strip-shaped pieces may directly form a grass inlet, and a specific grass inlet does not need to be disposed, thereby simplifying a structure of the protection mechanism, and reducing costs of the lawn mower.

A length of the middle portion gradually increases in a direction from the inner side to the outer side of the cutting mechanism, so that an accommodating region of the cutting mechanism also gradually increases in the direction from the inner side to the outer side of the cutting mechanism, to match a circular profile of the cutter head, and prevent interference between the cutting mechanism and the protection mechanism.

Strip-shaped pieces are disposed at intervals at the bottom of the cutting mechanism to serve as the protection mechanism. Compared with a protection form of another structure, for example, a channel structure, the strip-shaped piece can more effectively resolve a problem of grass stuck at the bottom of the protection mechanism. In addition, using the strip-shaped piece as the protection mechanism can reduce an overall weight of the protection mechanism. When the protection mechanism follows the cutting mechanism to move up and down or move left and right, a lighter weight of the protection mechanism corresponds to a smaller driving load of a driving motor, so that more energy in a battery package of the lawn mower can be allocated to the cutting mechanism and a walking mechanism, thereby improving lawn mowing efficiency of the lawn mower.

In addition, the strip-shaped piece also plays a role of a reinforcing bar. The strip-shaped piece can increase stability of the protection mechanism (for example, when the strip-shaped piece is connected to the first protection portion, the strip-shaped piece can strengthen a structure of the first protection portion, and increase stability of the structure of the first protection portion), so that the protection mechanism may not be deformed when touching and colliding with an obstacle, and the cutting mechanism is protected better.

In addition, the strip-shaped piece provides a better holding position for the user to carry the lawn mower. When the lawn mower is carried in a stopped state, the user may hold the strip-shaped piece to carry the lawn mower, thereby improving stability of the lawn mower during carrying, and avoiding a problem that the lawn mower falls during carrying.

In a possible implementation, there are only two strip-shaped pieces in the protection mechanism, and middle portions of the two strip-shaped pieces are disposed in parallel.

A smaller quantity of the strip-shaped pieces indicates a lighter overall weight of the protection mechanism. When there is one strip-shaped piece, protection effect at the bottom of the cutting mechanism is poor, affecting safety performance of the lawn mower. When there are two strip-shaped pieces, safety performance of the cutting mechanism has been verified to satisfy requirements of safety regulations, and compared with when there are three or more strip-shaped pieces, the overall weight of the protection mechanism is lighter, and less energy consumption is required for driving the protection mechanism to move.

In a possible implementation, the cutter head is circular, a plane on which an outer circumference of the cutter head is located is a first plane, and an orthographic projection of the innermost middle portion on the first plane at least partially coincides with the cutter head.

The orthographic projection of the middle portion on the first plane at least partially coincides with the cutter head. When obstacles are hidden in the lawn, the middle portion can prevent most of the obstacles from being in direct contact with the cutter head, thereby preventing the cutter head from touching the obstacle and being damaged, and improving a service life of the cutter head.

In a possible implementation, an orthographic projection of the outermost middle portion on the first plane does not coincide with the cutter head.

The orthographic projection of the outermost middle portion on the first plane does not coincide with the cutter head, so that an outer periphery of the cutter head is located between the innermost middle portion and the outermost middle portion, thereby ensuring protection effect of the strip-shaped piece for the cutter head.

In a possible implementation, a quantity of the protection mechanisms is two, a distance between two longest middle portions in the two protection mechanisms is a first distance, a distance between the outermost middle portion and the innermost middle portion in each of the protection mechanisms is a second distance, and the first distance is greater than the second distance.

In a possible implementation, the two protection mechanisms are symmetrically disposed along a central axis in a length direction of the body.

The two protection mechanisms use the protection form of the strip-shaped piece, which can further reduce the overall weight of the protection mechanism and reduce the energy consumption required for the protection mechanism to move.

In a possible implementation, the strip-shaped piece further includes bent portions, and the bent portions are respectively disposed at two ends of the middle portion.

The bent portion is configured to be connected to another structure in the protection mechanism, and the strip-shaped piece can be fixed without using an additional connecting structure, thereby simplifying an installation step and reducing installation costs.

In a possible implementation, a length of the bent portion is less than a length of the middle portion.

That the length of the bent portion is less than the length of the middle portion can improve mounting stability of the strip-shaped piece, and avoid deformation of the strip-shaped piece during operation of the lawn mower.

In a possible implementation, the strip-shaped piece is parallel to a forward direction of the lawn mower.

The strip-shaped piece is set to be parallel to the forward direction of the lawn mower, so that grass pressing and grass stuck of the strip-shaped piece can be avoided to the greatest extent, thereby improving lawn mowing efficiency.

In a possible implementation, a cross section of the strip-shaped piece is circular.

The cross section of the strip-shaped piece is set to be circular, which can reduce friction between the strip-shaped piece and the lawn, and reduce a probability of grass stuck of the protection mechanism. In addition, the strip-shaped piece is set to be circular, so that when the user holds the strip-shaped piece to carry the machine, a corner of the strip-shaped piece can be prevented from causing pressure on a hand of the user.

In a possible implementation, the blade is located between the cutter head and the middle portion.

In a possible implementation, an end of the middle portion close to a front end of the lawn mower is a first end, an end of the middle portion close to a rear end of the lawn mower is a second end, a first end of the innermost middle portion is closer to the front end of the lawn mower relative to a first end of the outermost middle portion, and a second end of the innermost middle portion is closer to the rear end of the lawn mower relative to a second end of the outermost middle portion.

In a possible implementation, the body has a first side edge and a second side edge that are oppositely disposed along a first direction, and the first direction intersects with a forward direction of the lawn mower;
the body has a third side edge and a fourth side edge that are oppositely disposed along a second direction, and the second direction is the forward direction of the lawn mower;
in the first direction, a distance between an outer side edge of the cutting mechanism and the first side edge of the body is a first distance, and a distance between the outer side edge of the cutting mechanism and the second side edge of the body is a second distance;
in the second direction, a distance between the outer side edge of the cutting mechanism and the fourth side edge of the body is a fourth distance, and the fourth side edge is a rear outer side edge of the lawn mower; and
the fourth distance is greater than the first distance and greater than the second distance.

The fourth distance is greater than the first distance and greater than the second distance. In this way, it can be ensured that a distance between the cutting mechanism and the fourth side edge of the body is large, thereby ensuring high safety performance at the fourth side edge of the body.

In a possible implementation, the body has a first side edge and a second side edge that are oppositely disposed along a first direction, and the first direction intersects with a forward direction of the lawn mower; and
the protection mechanism further includes a first protection portion, the first protection portion is disposed between the cutter head and the first side edge and/or between the cutter head and the second side edge.

In a possible implementation, along the forward direction of the lawn mower, a length of the first protection portion is greater than the length of the middle portion.

The length of the first protection portion is set to be greater than the length of the middle portion, so that protection effect of the first side edge and the second side edge of the lawn mower can be improved, thereby improving safety performance of the lawn mower during operation.

### BRIEF DESCRIPTION OF THE DRAWINGS

To describe technical solutions in embodiments of this application or in the prior art more clearly, the following briefly describes accompanying drawings required for describing embodiments or the prior art. Apparently, the accompanying drawings in the following descriptions show some embodiments of the present invention, and a person of ordinary skill in the art may still derive other drawings from these accompanying drawings without creative efforts.

FIG. 1 is a top view of a lawn mower according to an embodiment of this application;

FIG. 2 is a side view of a lawn mower according to an embodiment of this application;

FIG. 3 is a bottom view of a lawn mower according to an embodiment of this application;

FIG. 4 is a bottom view of a lawn mower without a protection mechanism according to an embodiment of this application;

FIG. 5 is a schematic diagram of a structure of a protection mechanism and a cutting mechanism of a lawn mower according to an embodiment of this application;

FIG. 6 is a schematic diagram of a structure of a protection mechanism and a cutting mechanism of a lawn mower according to an embodiment of this application;

FIG. 7 is a side view of a protection mechanism and a cutting mechanism of a lawn mower according to an embodiment of this application;

FIG. 8 is a schematic diagram of a structure of a protection mechanism and a cutting mechanism of a lawn mower according to an embodiment of this application;

FIG. 9 is a schematic diagram of a structure of a protection mechanism and a cutting mechanism of a lawn mower according to an embodiment of this application;

FIG. 10 is a schematic diagram of a structure of a protection mechanism and a cutting mechanism of a lawn mower according to an embodiment of this application;

FIG. 11 is a schematic diagram of a structure of a protection mechanism and a cutting mechanism of a lawn mower according to an embodiment of this application;

FIG. 12 is a side view of a protection mechanism and a cutting mechanism of a lawn mower according to an embodiment of this application;

FIG. 13 is a bottom view of a lawn mower according to an embodiment of this application; and

FIG. 14 is a bottom view of a lawn mower without a protection mechanism according to an embodiment of this application.

### DESCRIPTION OF SIGNS IN THE DRAWINGS

| | | |
|---|---|---|
| 100-lawn mower; | 10-body; | 11-first side edge; |
| 12-second side edge; | 13-third side edge; | 14-fourth side edge; |
| 20-cutting mechanism; | 21-cutter head; | 22-blade; |
| 23-mounting position; | 24-fixing piece; | 30-protection mechanism; |
| 30a-first protection mechanism; | 30b-second protection mechanism; | |
| 31-mounting portion; | 311-mounting hole; | 32-first protection portion; |
| 33-second protection portion; | 331-strip-shaped piece; | 3311-bent portion; |
| 3312-middle portion; | 3313-connection portion; | 34-grass inlet; |
| 35-guide plate; | 40-driving wheel; and | 50-driven wheel. |

### DETAILED DESCRIPTION

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are merely some embodiments of the present invention rather than all of the embodiments. All other embodiments obtained by a person of ordinary skill in the art based on the disclosed embodiments without creative efforts shall fall within the protection scope of the present invention.

The following describes in detail the lawn mower provided in the embodiments of this application with reference to the accompanying drawings.

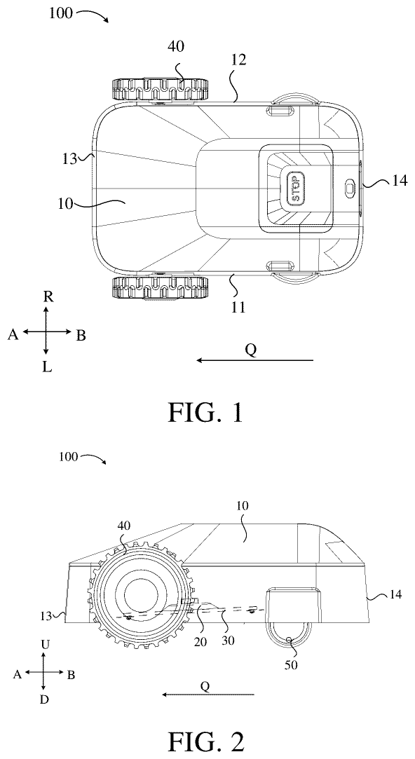

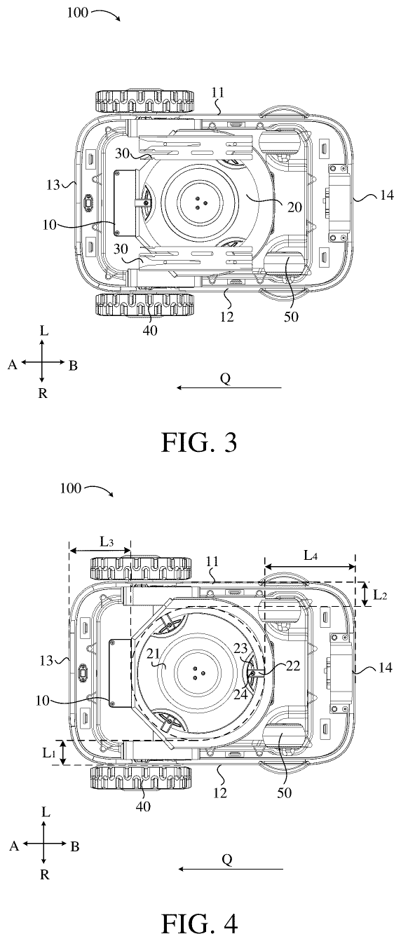

FIG. 1 is a top view of a lawn mower according to an embodiment of this application. FIG. 2 is a side view of a lawn mower according to an embodiment of this application. FIG. 3 is a bottom view of a lawn mower according to an embodiment of this application.

This application provides a lawn mower 100. As shown in FIG. 1, the lawn mower 100 may include a body 10. The body 10 has an output axis (not shown in the figure). The body 10 has a first side edge 11 and a second side edge 12 that are oppositely disposed along a first direction, and the first direction intersects with a forward direction of the lawn mower 100.

For example, the first direction may be perpendicular to the forward direction of the lawn mower 100, or the first direction may be set at an angle, such as 85° or 86°, with the forward direction of the lawn mower 100. In this embodiment of this application, the angle between the first direction and the forward direction of the lawn mower 100 is not further limited.

The first direction is set to be perpendicular to the forward direction of the lawn mower 100, so that safety performance of the lawn mower 100 can be improved. For example, when two ends located in the forward direction of the lawn mower 100 are respectively a front end and a rear end of the lawn mower 100, the first direction is set to be perpendicular to the forward direction of the lawn mower 100, and the first side edge and the second side edge of the body 10 are left and right sides of the lawn mower 100. In this way, there are protection barriers on the left and right sides of the lawn mower 100, thereby improving safety performance of the lawn mower 100.

As shown in FIG. 2, the lawn mower 100 may further include a cutting mechanism 20. The cutting mechanism 20 is located below the body 10 and is mounted in cooperation with the output axis, to perform a cutting operation driven by the output axis.

For example, a rotation center line of the cutting mechanism 20 coincides with an axis of the output axis. A control apparatus may be disposed on the body 10. The control apparatus is configured to drive the output axis to rotate, and the output axis rotates to drive a rotating structure to rotate, so that the rotating structure can perform a cutting operation.

In some embodiments, the control apparatus may be a motor or the like. In this embodiment of this application, a specific structure of the control apparatus is not further limited.

In a possible implementation, in the first direction, the cutting mechanism 20 may be located in the middle of the body 10. The cutting mechanism 20 is disposed in the middle of the body 10, so that a distance between the cutting mechanism 20 and the first side edge 11 is the same as a distance between the cutting mechanism 20 and the second side edge 12. In this way, when the lawn mower 100 is in operation, force-bearing locations of the first side edge 11 and the second side edge 12 of the body 10 are symmetrical, so that the body 10 is more easily balanced, and it is not easy to roll over.

As shown in FIG. 3, the lawn mower 100 may further include a protection mechanism 30. The protection mechanism 30 is disposed below the body 10. The protection mechanism 30 is disposed between the first side edge 11 and the cutting mechanism 20 and between the second side edge 12 and the cutting mechanism 20. The protection mechanism 30 is configured to establish protection barriers on the first side edge 11 and the second side edge 12 of the body 10, and below the body 10.

According to the lawn mower 100 in this embodiment of this application, the protection mechanism 30 is disposed between the cutting mechanism 20 and the first side edge 11 of the body 10 and between the cutting mechanism 20 and the second side edge 12 of the body 10, and the protection mechanism 30 is set to establish protection barriers on the first side edge 11 and the second side edge 12 of the body 10, and below the body 10, thereby improving safety performance of the lawn mower 100. In addition, a size of the cutting mechanism 20 can be increased to obtain a larger cutting width on the premise of safety regulations. In this way, the lawn mower 100 may be closer to an edge of a lawn to be cut, to have a larger cutting range and reduce a range of manual trimming, thereby improving automation of the intelligent lawn mower 100.

FIG. 4 is a bottom view of a lawn mower without a protection mechanism according to an embodiment of this application.

In the first direction, a distance between an outer side edge of the cutting mechanism 20 and the first side edge 11 of the body 10 is a first distance L1, and a distance between the outer side edge of the cutting mechanism 20 and the second side edge 12 of the body 10 is a second distance L2. In a second direction (a direction Q), a distance between the outer side edge of the cutting mechanism 20 and a third side edge 13 of the body 10 is a third distance L3. The third distance L3 is greater than the first distance L1 and greater than the second distance L2. In this way, it can be ensured that a distance between the cutting mechanism 20 and the third side edge 13 of the body 10 is large, thereby ensuring high safety performance at the third side edge 13 of the body 10.

It should be noted that, the first side edge 11 and the second side edge 12 of the body 10 refer to edges of the body 10 that are located outside the body 10 in the first direction and that are closest to the outer side edge of the cutting mechanism 20.

In a possible implementation, in the second direction (the direction Q), a distance between the outer side edge of the cutting mechanism 20 and a fourth side edge 14 of the body 10 is a fourth distance L4. The fourth distance is greater than the first distance L1 and greater than the second distance L2. In this way, it can be ensured that a distance between the cutting mechanism 20 and the fourth side edge 14 of the body 10 is large, thereby ensuring high safety performance at the fourth side edge 14 of the body 10.

It should be noted that, the outer side edge of the cutting mechanism 20 refers to an outer edge of the cutting mechanism 20 at a maximum size. As shown by the circular dashed box in FIG. 4, for example, when a blade 22 rotates to a position facing towards the third side edge 13 of the body 10, the third distance L3 is a distance between an end of the blade 22 away from a cutter head 21 and the third side edge 13. When the blade 22 rotates to a position facing towards the fourth side edge 14 of the body 10, the fourth distance L4 is a distance between the end of the blade 22 away from the cutter head 21 and the fourth side edge 14. The following describes the protection mechanism 30 in detail with reference to the accompanying drawings.

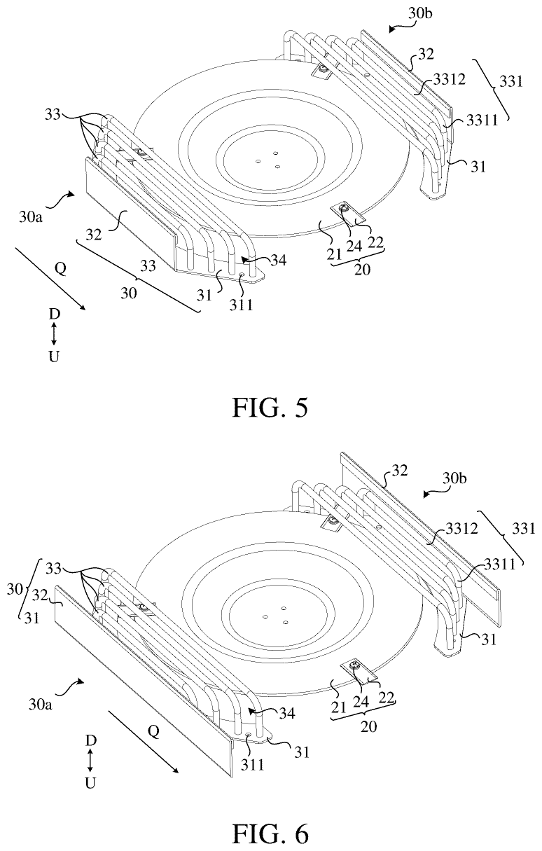

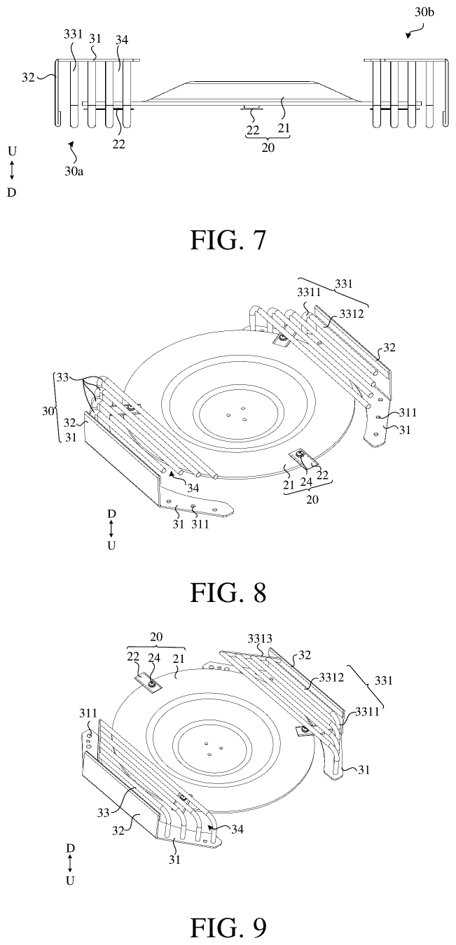

FIG. 5 is a schematic diagram of a structure of a protection mechanism 30 and a cutting mechanism 20 of a lawn mower 100 according to an embodiment of this application. FIG. 6 is a schematic diagram of a structure of a protection mechanism 30 and a cutting mechanism 20 of a lawn mower 100 according to an embodiment of this application. FIG. 7 is a side view of a protection mechanism 30 and a cutting mechanism 20 of a lawn mower 100 according to an embodiment of this application.

With reference to FIG. 4 and FIG. 5, the protection mechanism 30 is disposed between the first side edge 11 and the cutting mechanism 20 and between the second side edge 12 and the cutting mechanism 20.

For example, the protection mechanism 30 located between the first side edge 11 and the cutting mechanism 20 is used as a first protection mechanism 30a, and the protection mechanism 30 located between the second side edge 12 and the cutting mechanism 20 is used as a second protection mechanism 30b. The first protection mechanism 30a and the second protection mechanism 30b are oppositely disposed on two sides of the cutting mechanism 20, and structures of the first protection mechanism 30a and the second protection mechanism 30b may be the same. Certainly, in some other embodiments, structures of the first protection mechanism 30a and the second protection mechanism 30b may also be different.

That the structures of the first protection mechanism 30a and the second protection mechanism 30b are the same is used as an example below for description.

In a possible implementation, the first protection mechanism 30a may include a first protection portion 32 and a second protection portion 33. The first protection portion 32 is disposed between the first side edge 11 and the cutting mechanism 20, so that the first protection portion 32 of the first protection mechanism 30a may establish a protection barrier between the cutting mechanism 20 and the first side edge 11. At least a part of the structure of the second protection portion 33 of the first protection mechanism 30a is disposed below the cutting mechanism 20. All of the second protection portion 33 of the first protection mechanism 30a is configured to establish a protection barrier below the cutting mechanism 20.

The first protection mechanism 30a is set to include the first protection portion 32 and the second protection portion 33, so that different positions of the first protection mechanism 30a may form protection barriers at different orientations of the lawn mower 100, thereby improving safety of the lawn mower 100.

The second protection mechanism 30b may include a first protection portion 32 and a second protection portion 33. The first protection portion 32 of the second protection mechanism 30b is disposed between the second side edge 12 and the cutting mechanism 20, so that the first protection portion 32 of the second protection mechanism 30b may establish a protection barrier between the cutting mechanism 20 and the second side edge 12. At least a part of the structure of the second protection portion 33 of the second protection mechanism 30b is disposed below the cutting mechanism 20. All of the second protection portion 33 of the second protection mechanism 30b is configured to establish a protection barrier below the cutting mechanism 20.

The second protection mechanism 30b is set to include the first protection portion 32 and the second protection portion 33, so that different positions of the second protection mechanism 30b may form protection barriers at different orientations of the lawn mower 100, thereby improving safety of the lawn mower 100.

Still referring to FIG. 5, the protection mechanism 30 may further include a mounting portion 31. The mounting portion 31 is configured to fixedly connect the protection mechanism 30 to the body 10. For example, the first protection portion 32 may be connected to the mounting portion 31. The second protection portion 33 may also be connected to the mounting portion 31. Certainly, in some other embodiments, the second protection portion 33 may alternatively be connected to the first protection portion 32 (referring to FIG. 11).

For example, the mounting portion 31, the first protection portion 32, and the second protection portion 33 may be fixedly connected or detachably connected through welding, riveting, clamping, or integral forming. In this embodiment of this application, a connection manner among the mounting portion 31, the first protection portion 32, and the second protection portion 33 is not further limited.

The mounting portion 31 is disposed to connect the first protection portion 32 and the second protection portion 33 to the body 10, and improve connection stability between the first protection portion 32 and the second protection portion 33 with the body 10, thereby improving a service life of the lawn mower 100.

For example, the mounting portion 31 may be in a plate-shaped structure, and the mounting portion 31 is provided with a mounting hole 311 for connecting to the body 10. The body 10 and the mounting portion 31 may be connected by using a screwing. Certainly, in another embodiment, the body 10 and the mounting portion 31 may also be connected through buckling. That is, a buckle may be disposed below the body 10, and the mounting portion 31 is snapped in the buckle. In this embodiment of this application, a connection manner between the body 10 and the mounting portion 31 is not further limited.

In a possible implementation, the first protection portion 32 may be in a plate shape. For example, the first protection portion 32 may be disposed at an end of the mounting portion 31 away from a center of the cutter head 21. One end of the first protection portion 32 is connected to the mounting portion 31, and the other end of the first protection portion 32 extends, toward a side away from the body 10, below the cutter head 21, so that the first protection portion 32 may establish a protection barrier on a lateral side of the cutting mechanism 20. The first protection portion 32 and the mounting portion 31 may be formed by bending a piece of sheet material by 90° or at another angle. In another embodiment, the first protection portion 32 may also be of another shape.

It should be noted that, as shown in FIG. 5, a length of the first protection portion 32 in the forward direction (the direction Q) of the lawn mower 100 may be less than that of the second protection portion 33. Certainly, in some other embodiments, as shown in FIG. 6, the length of the first protection portion 32 in the forward direction of the lawn mower 100 may be greater than or equal to that of the second protection portion 33. In this way, a protection region of the first protection portion 32 may be enlarged, thereby improving safety performance of the lawn mower 100.

The first protection portion 32 is set to be in a plate shape. In this way, a structure of the first protection portion 32 may be simplified, so that the first protection portion 32 may form protection barriers at the first side edge 11 and the second side edge 12 of the body 10. In addition, blocking performance of the plate-shaped structure is good, and an object may be prevented from contacting the cutting mechanism 20 from the first side edge 11 and the second side edge 12 of the body 10, thereby improving safety of the lawn mower 100.

As shown in FIG. 7, in a vertical direction, an end of the second protection portion 33 facing the body 10 is connected to the mounting portion 31. An end of the second protection portion 33 away from the body 10 is located below the cutting mechanism 20. The end of the second protection portion 33 away from the body 10 is disposed below the cutting mechanism 20, so that the second protection portion 33 may establish a protection barrier below the cutting mechanism 20.

It should be noted that, in this embodiment of this application, the vertical direction refers to a thickness direction of the lawn mower, that is, an up-and-down direction in the figure. In this embodiment of this application, the down direction refers to a direction closer to the lawn in a vertical direction when the lawn mower is in a use state.

Still referring to FIG. 5 and FIG. 6, at least one end of the second protection portion 33 along the forward direction of the lawn mower 100 is provided with at least one grass inlet 34.

At least one end of the second protection portion 33 is provided with the grass inlet 34, so that when the lawn mower 100 is used to cut grass, the grass may be in contact with the cutting mechanism 20 through the grass inlet 34, and is further cut by the cutting mechanism 20, to achieve the purpose of cutting the grass.

In a possible implementation, the second protection portion 33 may include at least two strip-shaped pieces 331, and the at least two strip-shaped pieces 331 are separately mounted in cooperation with the mounting portion 31. The at least two strip-shaped pieces 331 are disposed at intervals in the first direction. A gap between adjacent strip-shaped pieces 331 forms the grass inlet 34.

In this embodiment, each strip-shaped piece 331 is disposed along the forward direction of the lawn mower 100, that is, each strip-shaped piece 331 is parallel to the forward direction, so that all the strip-shaped pieces 331 are disposed parallel to each other, and gaps between the strip-shaped pieces 331 form the grass inlet 34. In another embodiment, alternatively, the strip-shaped piece 331 may be disposed at an angle with the forward direction of the lawn mower 100, which may be an angle of 10° to 40°.

The second protection portion 33 is provided with at least two strip-shaped pieces 331, so that a structure of the second protection portion 33 can be simplified, processing and installation are facilitated, and costs are reduced. In addition, the strip-shaped pieces 331 are disposed at intervals, so that the grass inlet 34 can be directly formed, a specific grass inlet 34 does not need to be disposed, the structure of the second protection portion 33 is simplified, and costs are reduced.

For example, the second protection portion 33 may include two, three, four, or five strip-shaped pieces 331, which may be specifically set based on a size of the cutting mechanism 20. In this embodiment of this application, a quantity of the strip-shaped pieces 331 in the second protection portion 33 is not further limited.

In this embodiment of this application, the strip-shaped piece 331 may be in a cylindrical shape. Certainly, in another embodiment, the strip-shaped piece 331 may also be set to be a prismatic shape or another shape. In this embodiment of this application, a specific shape of the strip-shaped piece 331 is not further limited.

The strip-shaped piece 331 is set to be the cylindrical shape, so that processing difficulty of the strip-shaped piece 331 is reduced, thereby reducing costs. In addition, the cylindrical structure has a rounded surface and does not have sharp positions such as corners, so that a user may not be accidentally scratched, and safety performance is high. In addition, the grass is easier to enter, and it is not easier to get stuck.

It should be noted that, in this embodiment of this application, a spacing distance between two adjacent strip-shaped pieces 331 is not further limited in this embodiment of this application. In addition, sizes of a plurality of strip-shaped pieces 331 may be the same or may be different.

As shown in FIG. 5, in a direction from an outer side to an inner side of the cutting mechanism 20, sizes of the strip-shaped pieces 331 gradually increase, so that the plurality of strip-shaped pieces 331 may be located at the outer side of the cutting mechanism 20. Further, a protection barrier is formed on the outer side of the cutting mechanism 20.

Certainly, in another embodiment, the plurality of strip-shaped pieces 331 may be set to have the same length as a strip-shaped piece 331 with a largest size in FIG. 5. In this way, the plurality of strip-shaped pieces 331 may also be located at the outer side of the cutting mechanism 20. In this embodiment of this application, the size of the strip-shaped piece 331 is not further limited in this embodiment of this application.

Still referring to FIG. 5, in the second direction (the direction Q), at least one end of each strip-shaped piece 331 is provided with a bent portion, and the bent portion is bent toward the mounting portion 31. At least one bent portion on each strip-shaped piece 331 is connected to the mounting portion 31.

The bent portion is disposed on the strip-shaped piece 331, so that the strip-shaped piece 331 is connected to the mounting portion 31, thereby improving connection stability between the second protection portion 33 and the mounting portion 31. In addition, the bent portion is disposed, so that a part of the structure of the strip-shaped piece 331 is located below the cutting mechanism 20, and another part of the structure of the strip-shaped piece 331 is connected to the mounting portion 31. In this way, the second protection portion 33 may establish a protection barrier below the cutting mechanism 20.

For example, as shown in FIG. 5 and FIG. 6, two ends of the strip-shaped piece 331 may be provided with the bent portion. A bent portion of each strip-shaped piece 331 is connected to the mounting portion 31. Between two bent portions 3311 is a middle portion 3312. The strip-shaped piece 331, the mounting portion 31, and the first protection portion 32 enclose an accommodating region for accommodating a part of the cutter head 21. A length of the middle portion 3312 gradually increases in the direction from the outer side to the inner side of the cutting mechanism 20, so that the accommodating region also gradually increases in the direction from the outer side to the inner side of the cutting mechanism 20, to match a circular profile of the cutter head 21, and prevent interference between the cutting mechanism 20 and the protection mechanism 30.

Two ends of the strip-shaped piece 331 are provided with the bent portion, so that connection stability between the second protection portion 33 and the mounting portion 31 may be improved, thereby improving a service life of the second protection portion 33.

For example, an outer end of each bent portion 3311 and the mounting portion 31 are detachably mounted or integrally formed. A gap between bent portions 3311 at two ends of each strip-shaped piece 331 is provided for the grass to pass through, and there is no obstacle for the grass to exit on both sides.

In some other embodiments, as shown in FIG. 8, one end of the strip-shaped piece 331 is provided with a bent portion. The end provided with the bent portion may be an end of the strip-shaped piece 331 facing the third side edge 13 of the body 10, or may be an end of the strip-shaped piece 331 facing the fourth side edge 14 of the body 10.

An end of the strip-shaped piece 331 close to the third side edge 13 of the body 10 is provided with the bent portion. In this way, connection stability between the strip-shaped piece 331 and the mounting portion 31 may be improved.

An end of each strip-shaped piece 331 close to the fourth side edge 14 of the body 10 is provided with the bent portion. In this way, obstruction for the second protection portion 33 in the forward direction of the lawn mower 100 may be reduced, and it is convenient for the grass to enter from the grass inlet 34 and contact with the cutting mechanism 20, which can improve efficiency of the lawn mower 100.

In some other embodiments, one end of some strip-shaped pieces 331 in the plurality of strip-shaped pieces 331 facing the third side edge 13 of the body 10 is provided with a bent portion, and one end of some other strip-shaped pieces 331 in the plurality of strip-shaped pieces 331 facing the fourth side edge 14 of the body 10 is provided with a bent portion. For example, a strip-shaped piece 331 with an end facing the third side edge 13 of the body 10 provided with a bent portion and a strip-shaped piece 331 with an end facing the fourth side edge 14 of the body 10 provided with a bent portion may be staggered. In this way, the grass inlet 34 is also enlarged, obstruction for the second protection portion 33 in the forward direction of the lawn mower 100 may be reduced, and it is convenient for the grass to enter from the grass inlet 34 and contact with the cutting mechanism 20, which can improve efficiency of the lawn mower 100.

It should be noted that, in this embodiment of this application, a quantity and disposition positions of bent portions on each strip-shaped piece 331 are not further limited.

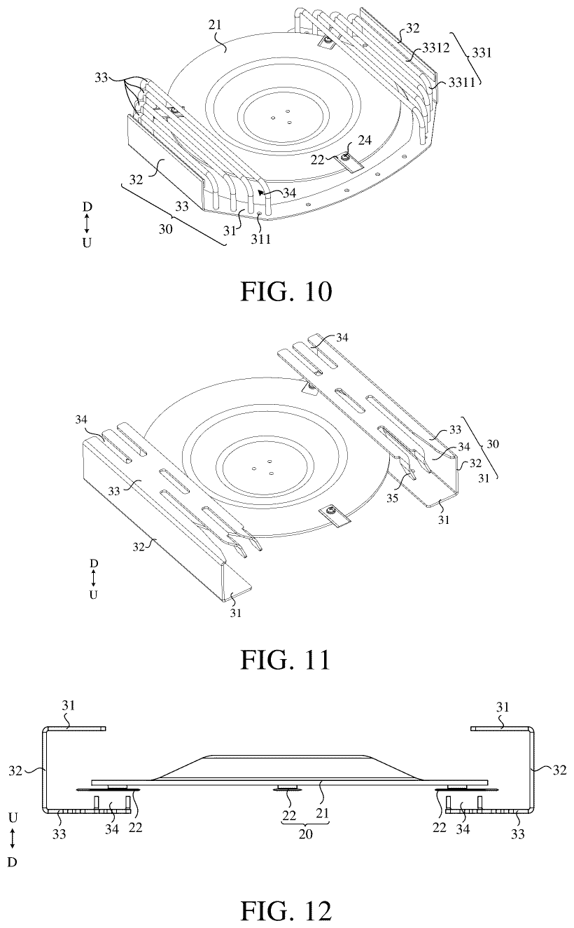

It should be noted that, in the foregoing embodiment, the mounting portion 31 of the first protection mechanism 30a and the mounting portion 31 of the second protection mechanism 30b are separately disposed. In some other embodiments, as shown in FIG. 10, the mounting portion 31 of the first protection mechanism 30a and the mounting portion 31 of the second protection mechanism 30b may be disposed as a whole. In this way, a position at which the mounting portion 31 is configured to connect to the body 10 may be added, thereby improving connection stability between the protection mechanism 30 and the body 10.

Certainly, in another embodiment, the protection mechanism 30 may alternatively be in another structure. For example, the protection mechanism 30 may be set to be in an integrated structure. As shown in FIG. 11, the second protection portion 33 includes a plate-shaped structure, and the second protection portion 33 is disposed at an end of the first protection portion 32 away from the body 10. In the first direction, the second protection portion 33 extends from an outer side edge of the cutting mechanism 20 to a center of the cutting mechanism 20.

Certainly, in another embodiment, the protection mechanism 30 may also be set to be in another structure. In this embodiment of this application, no further description is provided.

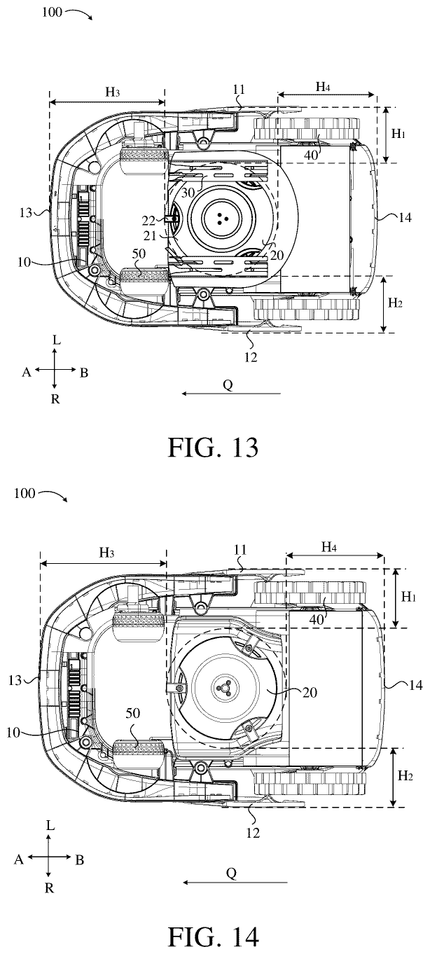

This application further provides a lawn mower 100. As shown in FIG. 13, the lawn mower 100 includes a body 10, the body 10 has a first side edge 11 and a second side edge 12 that are oppositely disposed along a first direction, and the first direction intersects with a forward direction of the lawn mower 100.

For example, the first direction may be perpendicular to the forward direction of the lawn mower 100, or the first direction may be set at an angle, such as 85° or 86°, with the forward direction of the lawn mower 100. In this embodiment of this application, the angle between the first direction and the forward direction of the lawn mower 100 is not further limited.

The first direction is set to be perpendicular to the forward direction of the lawn mower 100, so that safety performance of the lawn mower 100 can be improved. For example, when two ends located in the forward direction of the lawn mower 100 are respectively a front end and a rear end of the lawn mower 100, the first direction is set to be perpendicular to the forward direction of the lawn mower 100, and the first side edge 11 and the second side edge 12 of the body 10 are left and right sides of the lawn mower 100. In this way, there are protection barriers on the left and right sides of the lawn mower 100, thereby improving safety performance of the lawn mower 100.

As shown in FIG. 13, the lawn mower 100 may further include a cutting mechanism 20. The cutting mechanism 20 is located below the body 10 and is configured to perform a cutting operation.

For example, an output axis (not shown in the figure) may be disposed on the body 10, and the output axis is mounted in cooperation with the cutting mechanism. The output axis is configured to drive the cutting mechanism to rotate, so that the cutting mechanism may perform a cutting operation.

For example, a rotation center line of the cutting mechanism 20 coincides with an axis of the output axis. A control apparatus may be disposed on the body 10. The control apparatus is configured to drive the output axis to rotate, and the output axis rotates to drive a rotating structure to rotate, so that the rotating structure can perform a cutting operation.

In some embodiments, the control apparatus may be a motor or the like. In this embodiment of this application, a specific structure of the control apparatus is not further limited.

In a possible implementation, in the first direction, the cutting mechanism 20 may be located in the middle of the body 10. The cutting mechanism 20 is disposed in the middle of the body 10, so that a distance between the cutting mechanism 20 and the first side edge 11 is the same as a distance between the cutting mechanism 20 and the second side edge 12. In this way, when the lawn mower 100 is in operation, force-bearing locations of the first side edge 11 and the second side edge 12 of the body 10 are symmetrical, so that the body 10 is more easily balanced, and it is not easy to roll over.

In this embodiment of this application, in the first direction, a distance between an outer side edge of the cutting mechanism 20 and the first side edge 11 of the body 10 is a first distance H₁, and a distance between the outer side edge of the cutting mechanism 20 and the second side edge 12 of the body 10 is a second distance H₂. The first distance H₁ and/or the second distance H₂ are/is less than 50 mm.

The first distance H₁ and/or the second distance H₂ are/is set to be less than 50 mm. In this way, it can be ensured that a distance between the cutting mechanism 20 and an outer side of the body 10 is small, which is beneficial for the lawn mower 100 to be closer to an edge of the lawn to be cut, and reduces a range of manual trimming, thereby improving automation of the intelligent lawn mower 100.

It should be noted that, the first side edge 11 and the second side edge 12 of the body 10 refer to edge positions that are on the outer side of the body 10 in the first direction.

It should be noted that, in this embodiment of this application, the lawn mower 100 may further include a driving wheel 40 and a driven wheel 50. The driving wheel 40 is mounted at a rear end of the body 10, and the driven wheel 50 is mounted at a front end of the body 10. Alternatively, the driving wheel 40 may be mounted at the front end of the body 10, and the driven wheel 50 is mounted at the rear end of the body 10.

As shown in FIG. 13, two driving wheels 40 are respectively mounted on an inner side of the rear end of the body 10. The driving wheel 40 is driven by a motor on the body 10, that is, the lawn mower 100 is a rear-drive lawn mower 100. The driven wheel 50 is mounted on an inner side of the front end of the body 10, and the driven wheel 50 is preferably a universal wheel. The driving wheel 40 and the driven wheel 50 are disposed, so that the lawn mower 100 may move and steer.

For example, a direction from the driving wheel 40 to the driven wheel 50 is the forward direction of the lawn mower 100.

For example, the first distance H₁ is equal to the second distance H₂, and both the first distance H₁ and the second distance H₂ may be 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, 50 mm, or the like.

In this embodiment of this application, specific values of the first distance H₁ and the second distance H₂ are not further limited.

It should be noted that, for ease of description, the direction Q in the figure represents the forward direction of the lawn mower, that is, the second direction. A direction L in the figure refers to a direction towards a left end, a left side, or a first side edge of the lawn mower. A direction R refers to a direction towards a right end, a right side, or a second side edge of the lawn mower. A direction A refers to a direction towards a front end, a front side, or a third side edge of the lawn mower. A direction B refers to a direction towards a rear end, a rear side, or a fourth side edge of the lawn mower. A direction U refers to an upper direction, D refers to a lower direction, and a vertical direction and a thickness direction of the lawn mower are directions of D and U in the figure.

The protection mechanism 30 is not disposed between the third side edge 13 and the cutting mechanism 20, so that a structure of the lawn mower 100 can be simplified, thereby reducing costs.

It should be noted that, when the body 10 is quadrangular as shown in FIG. 13, the first side edge 11 and the second side edge 12 are two opposite side edges. Specifically, in this embodiment of this application, the first side edge 11 and the second side edge 12 are respectively outer side edges on the left side and the right side of the body 10. The third side edge 13 and the fourth side edge 14 are respectively two side edges oppositely disposed at a front end and a rear end of the body 10. Specifically, in this embodiment of this application, the third side edge 13 and the fourth side edge 14 are outer side edges on the front side and the rear side of the body 10.

In some embodiments, there are two protection mechanisms 30. The two protection mechanisms 30 are oppositely disposed between the first side edge 11 of the body 10 and the cutting mechanism 20 and between the second side edge 12 and the cutting mechanism 20.

The following describes a specific structure of the cutting mechanism 20 in detail.

FIG. 14 is a bottom view of a lawn mower 100 without a protection mechanism 30 according to an embodiment of this application.

As shown in FIG. 14, the cutting mechanism 20 includes a cutter head 21 and a blade 22 mounted on the cutter head 21. An output axis is mounted in cooperation with the cutter head 21 to drive the cutter head 21 to rotate. In this embodiment, a rotation center line of the cutting mechanism 20 is a rotation center line of the cutter head 21.

In this embodiment, there are three blades 22, and the three blades 22 are evenly mounted on the cutter head 21 in a peripheral direction of the cutter head 21. An end of the blade 22 away from a center of the cutter head 21 extends beyond the cutter head 21, so that the blade 22 may perform a cutting operation.

In this embodiment, the blade 22 may be mounted on the cutter head 21 in a rotating manner by using a mounting piece such as a screw or a rotation axis. That is, the blade 22 may freely rotate, and also rotates with rotation of the cutter head 21. In this way, the blade 22 may have some degrees of freedom, a force between the blade 22 and the obstacle may be reduced in a case of encountering with an obstacle such as a small stone, and the blade may be effectively protected from being damaged.

In a possible implementation, as shown in FIG. 14, in a first direction, a distance between an outer side edge of the cutting mechanism 20 and a first side edge 11 of the body 10 is a first distance H₁, and a distance between the outer side edge of the cutting mechanism 20 and a second side edge 12 of the body 10 is a second distance H₂. In a second direction, a distance between the outer side edge of the cutting mechanism 20 and a third side edge 13 of the body 10 is a third distance H₃. The third distance H₃ is greater than the first distance H₁ and is greater than the second distance H₂. In this way, it can be ensured that a distance between the cutting mechanism 20 and the third side edge 13 of the body 10 is large, thereby ensuring high safety performance at the third side edge 13 of the body 10.

In a possible implementation, in the second direction (the direction Q), a distance between the outer side edge of the cutting mechanism 20 and a fourth side edge 14 of the body 10 is a fourth distance H₄. The fourth distance is greater than the first distance H₁ and is greater than the second distance H₂. In this way, it can be ensured that a distance between the cutting mechanism 20 and the fourth side edge 14 of the body 10 is large, thereby ensuring high safety performance at the fourth side edge 14 of the body 10.

It should be noted that, the outer side edge of the cutting mechanism 20 is an outer edge of the cutting mechanism 20 at a maximum size, as shown by a circular dashed line box in FIG. 14. For example, when the blade 22 rotates to a position facing towards the third side edge 13 of the body 10, the third distance H₃ is a distance between an end of the blade 22 away from the cutter head 21 and the third side edge 13. When the blade 22 rotates to a position facing towards the fourth side edge 14 of the body 10, the fourth distance H₄ is a distance between the end of the blade 22 away from the cutter head 21 and the fourth side edge 14.

It should be noted that, a structure and a principle of the protection mechanism 30 in this embodiment of this application and cooperation with other components are the same as those of the protection mechanism 30 described in FIG. 5 to FIG. 12. For details, refer to the descriptions of the protection mechanism 30 in the foregoing embodiment. In this embodiment of this application, the structure of the protection mechanism 30 is not described again.

This application further provides a lawn mower 100. Referring to FIG. 5, FIG. 6, FIG. 12, FIG. 13, and FIG. 14, the lawn mower 100 includes: a body 10, where the body 10 has an output axis;
a cutting mechanism, where the cutting mechanism is located below the body 10 and is mounted in cooperation with the output axis, and the cutting mechanism 20 includes a cutter head 21 and a blade 22 mounted on the cutter head 21; and
a protection mechanism 30, where at least a part of the protection mechanism 30 is located below the cutting mechanism 20.

The protection mechanism 30 includes at least two strip-shaped pieces 331 disposed at intervals, the strip-shaped piece 331 includes a middle portion 3312, the cutter head 21 is located above the middle portion 3312, and a length of the middle portion 3312 gradually increases in a direction from an outer side to an inner side of the cutting mechanism 20.

In this application, the protection mechanism 30 is set to include at least two strip-shaped pieces 331. The two strip-shaped pieces 331 may simplify a structure of the protection mechanism 30, facilitate processing and installation, and further reduce costs. In addition, the strip-shaped pieces 331 are disposed at intervals, a gap between the strip-shaped pieces 331 may directly form a grass inlet, and a specific grass inlet does not need to be disposed, thereby simplifying a structure of the protection mechanism 30, and reducing costs of the lawn mower 100.

A length of the middle portion 3312 gradually increases in a direction from the inner side to the outer side of the cutting mechanism 20, so that an accommodating region of the cutting mechanism 20 also gradually increases in the direction from the inner side to the outer side of the cutting mechanism 20, to match a circular profile of the cutter head 21, and prevent interference between the cutting mechanism 20 and the protection mechanism 30.

Strip-shaped pieces 331 are disposed at intervals at the bottom of the cutting mechanism 20 to serve as the protection mechanism. Compared with a protection form of another structure, for example, a channel structure, the strip-shaped piece 331 can more effectively resolve a problem of grass stuck at the bottom of the protection mechanism 30. In addition, using the strip-shaped piece 331 as the protection mechanism 30 can reduce an overall weight of the protection mechanism 30. When the protection mechanism 30 follows the cutting mechanism 20 to move up and down or move left and right, a lighter weight of the protection mechanism 30 corresponds to a smaller driving load of a driving motor, so that more energy in a battery package of the lawn mower 100 can be allocated to the cutting mechanism 20 and a walking mechanism, thereby improving lawn mowing efficiency of the lawn mower 100.

In addition, the strip-shaped piece 331 also plays a role of a reinforcing bar. The strip-shaped piece 331 can increase stability of the protection mechanism 30 (for example, when the strip-shaped piece 331 is connected to the first protection portion 32, the strip-shaped piece 331 can strengthen a structure of the first protection portion 32, and increase stability of the structure of the first protection portion 32), so that the protection mechanism 30 may not be deformed when touching and colliding with an obstacle, and the cutting mechanism 20 is protected better.

In addition, the strip-shaped piece 331 provides a better holding position for the user to carry the lawn mower 100. When the lawn mower 100 is carried in a stopped state, the user may hold the strip-shaped piece 331 to carry the lawn mower 100, thereby improving stability of the lawn mower 100 during carrying, and avoiding a problem that the lawn mower 100 falls during carrying.

In a possible implementation, there are only two strip-shaped pieces 331 in the protection mechanism 30, and middle portions 3312 of the two strip-shaped pieces 331 are disposed in parallel.

A smaller quantity of the strip-shaped pieces 331 indicates a lighter overall weight of the protection mechanism 30. When there is one strip-shaped piece 331, protection effect at the bottom of the cutting mechanism 20 is poor, affecting safety performance of the lawn mower 100. When there are two strip-shaped pieces 331, safety performance of the cutting mechanism 20 has been verified to satisfy requirements of safety regulations, and compared with when there are three or more strip-shaped pieces 331, the overall weight of the protection mechanism 30 is lighter, and less energy consumption is required for driving the protection mechanism 30 to move.

In a possible implementation, the cutter head 21 is circular, a plane on which an outer circumference of the cutter head 21 is located is a first plane, and an orthographic projection of the innermost middle portion 3312 on the first plane at least partially coincides with the cutter head 21.

The orthographic projection of the middle portion 3312 on the first plane at least partially coincides with the cutter head 21. When obstacles are hidden in the lawn, the middle portion 3312 can prevent most of the obstacles from being in direct contact with the cutter head 21, thereby preventing the cutter head 21 from touching the obstacle and being damaged, and improving a service life of the cutter head 21.

In a possible implementation, an orthographic projection of the outermost middle portion 3312 on the first plane does not coincide with the cutter head 21.

The orthographic projection of the outermost middle portion 3312 on the first plane does not coincide with the cutter head 21, so that an outer periphery of the cutter head 21 is located between the innermost middle portion 3312 and the outermost middle portion 3312, thereby ensuring protection effect of the strip-shaped piece 331 for the cutter head 21.

In a possible implementation, a quantity of the protection mechanisms 30 is two, a distance between two longest middle portions 3312 in the two protection mechanisms 30 is a first distance, a distance between the outermost middle portion 3312 and the innermost middle portion 3312 in each of the protection mechanisms 30 is a second distance, and the first distance is greater than the second distance.

In a possible implementation, the two protection mechanisms 30 are symmetrically disposed along a central axis in a length direction of the body 10.

The two protection mechanisms 30 use the protection form of the strip-shaped piece 331, which can further reduce the overall weight of the protection mechanism 30 and reduce the energy consumption required for the protection mechanism 30 to move.

In a possible implementation, the strip-shaped piece further includes bent portions 3313, and the bent portions 3313 are respectively disposed at two ends of the middle portion 3312.

The bent portion 3313 is configured to be connected to another structure in the protection mechanism 30, and the strip-shaped piece 331 can be fixed without using an additional connecting structure, thereby simplifying an installation step and reducing installation costs.

In a possible implementation, a length of the bent portion 3313 is less than a length of the middle portion 3312.

That the length of the bent portion 3313 is less than the length of the middle portion 3312 can improve mounting stability of the strip-shaped piece 331, and avoid deformation of the strip-shaped piece 331 during operation of the lawn mower 100.

In a possible implementation, the strip-shaped piece 331 is parallel to a forward direction of the lawn mower 100.

The strip-shaped piece 331 is set to be parallel to the forward direction of the lawn mower 100, so that grass pressing and grass stuck of the strip-shaped piece 331 can be avoided to the greatest extent, thereby improving lawn mowing efficiency.

In a possible implementation, a cross section of the strip-shaped piece 331 is circular.

The cross section of the strip-shaped piece 331 is set to be circular, which can reduce friction between the strip-shaped piece 331 and the lawn, and reduce a probability of grass stuck of the protection mechanism 30. In addition, the strip-shaped piece 331 is set to be circular, so that when the user holds the strip-shaped piece to carry the machine, a corner of the strip-shaped piece 331 can be prevented from causing pressure on a hand of the user.

In a possible implementation, the blade 22 is located between the cutter head 21 and the middle portion.

In a possible implementation, an end of the middle portion 3312 close to a front end of the lawn mower 100 is a first end, an end of the middle portion 3312 close to a rear end of the lawn mower 100 is a second end, a first end of the innermost middle portion 3312 is closer to the front end of the lawn mower 100 relative to a first end of the outermost middle portion 3312, and a second end of the innermost middle portion 3312 is closer to the rear end of the lawn mower 100 relative to a second end of the outermost middle portion 3312.

In a possible implementation, the body 10 has a first side edge 11 and a second side edge 12 that are oppositely disposed along a first direction, and the first direction intersects with a forward direction of the lawn mower 100;
the body 10 has a third side edge 13 and a fourth side edge 15 that are oppositely disposed along a second direction, and the second direction is the forward direction of the lawn mower 10;
in the first direction, a distance between an outer side edge of the cutting mechanism 20 and the first side edge 11 of the body 10 is a first distance, and a distance between the outer side edge of the cutting mechanism 20 and the second side edge 12 of the body is a second distance;
in the second direction, a distance between the outer side edge of the cutting mechanism 20 and the fourth side edge 15 of the body is a fourth distance, and the fourth side edge 14 is a rear outer side edge of the lawn mower 100; and
the fourth distance is greater than the first distance and greater than the second distance.

The fourth distance is greater than the first distance and greater than the second distance. In this way, it can be ensured that a distance between the cutting mechanism 20 and the fourth side edge 14 of the body 10 is large, thereby ensuring high safety performance at the fourth side edge 14 of the body 10.

In a possible implementation, the body 10 has a first side edge 11 and a second side edge 12 that are oppositely disposed along a first direction, and the first direction intersects with a forward direction of the lawn mower 100; and
the protection mechanism 30 further includes a first protection portion 32, the first protection portion 32 is disposed between the cutter head 21 and the first side edge 11 and/or between the cutter head 21 and the second side edge 12.

In a possible implementation, along the forward direction of the lawn mower 100, a length of the first protection portion 32 is greater than the length of the middle portion 3312.

The length of the first protection portion 32 is set to be greater than the length of the middle portion 3312, so that protection effect of the first side edge 11 and the second side edge 12 of the lawn mower 100 can be improved, thereby improving safety performance of the lawn mower 100 during operation.

In the descriptions of this application, it should be understood that an orientation or positional relationship indicated by the term “center”, “longitudinal”, “transverse”, “length”, “width”, “thickness”, “above”, “beneath”, “front”, “back”, “left”, “right”, “vertical”, “horizontal”, “top”, “bottom”, “internal”, “external”, or the like is based on an orientation or positional relationship shown in the accompanying drawings, and is merely for ease of describing this application and simplifying description, but does not indicate or imply that an apparatus or an element referred to needs to have a specific orientation or be constructed and operated in a specific orientation, and therefore cannot be understood as a limitation on this application.

In the descriptions of this application, it should be understood that terms “include”, “have” and any other variants used in this specification are intended to cover non-exclusive inclusion, for example, a process, method, system, product, or device that includes a list of steps or units is not necessarily limited to those expressly listed steps or units, but may include other steps or units not expressly listed or inherent to such a process, method, product, or device.

Unless specifically defined and limited otherwise, terms “installed”, “linked”, “connected”, “fixed”, and the like should be understood in a broad sense, for example, it may be a fixed connection, a detachable connection, or a whole; and it may be a direct link or an indirect link through an intermediary, and it may be an internal connection between two elements or an interaction relationship between two elements. A person of ordinary skill in the art may understand the specific meanings of the foregoing terms in this application according to specific situations. Moreover, the terms such as “first” and “second” are used only for the purpose of description and cannot be understood as indicating or implying relative importance or implicitly indicating the number of technical features denoted.

Finally, it should be noted that: the foregoing embodiments are merely used for describing the technical solutions of this application, but are not intended to limit this application. Although this application is described in detail with reference to the foregoing embodiments, it should be appreciated by a person of ordinary skill in the art that, modifications may still be made to the technical solutions described in the foregoing embodiments, or equivalent replacements may be made to the part or all of the technical features; and these modifications or replacements will not cause the essence of corresponding technical solutions to depart from the scope of the technical solutions in the embodiments of this application.

What is claimed is:

1. A lawn mower, comprising:
a body, wherein the body has an output axis;
a cutting mechanism, wherein the cutting mechanism is located below the body and is mounted in cooperation with the output axis, and the cutting mechanism comprises a cutter head and a blade mounted on the cutter head; and
a protection mechanism, wherein at least a part of the protection mechanism is located below the cutting mechanism; and
the protection mechanism comprises at least two strip-shaped pieces disposed at intervals, the strip-shaped piece comprises a middle portion, the cutter head is located above the middle portion, and a length of the middle portion gradually increases in a direction from an outer side to an inner side of the cutting mechanism.

2. The lawn mower according to claim 1, wherein there are only two strip-shaped pieces in the protection mechanism, and middle portions of the two strip-shaped pieces are disposed in parallel.

3. The lawn mower according to claim 1, wherein the cutter head is circular, a plane on which an outer circumference of the cutter head is located is a first plane, and an orthographic projection of the innermost middle portion on the first plane at least partially coincides with the cutter head.

4. The lawn mower according to claim 3, wherein an orthographic projection of the outermost middle portion on the first plane does not coincide with the cutter head.

5. The lawn mower according to claim 1, wherein a quantity of the protection mechanisms is two, a distance between two longest middle portions in the two protection mechanisms is a first distance, a distance between the outermost middle portion and the innermost middle portion in each of the protection mechanisms is a second distance, and the first distance is greater than the second distance.

6. The lawn mower according to claim 5, wherein the two protection mechanisms are symmetrically disposed along a central axis in a length direction of the body.

7. The lawn mower according to claim 1, wherein the strip-shaped piece further comprises bent portions, and the bent portions are respectively disposed at two ends of the middle portion.

8. The lawn mower according to claim 1, wherein a length of the bent portion is less than the length of the middle portion.

9. The lawn mower according to claim 1, wherein the strip-shaped piece is parallel to a forward direction of the lawn mower.

10. The lawn mower according to claim 1, wherein a cross section of the strip-shaped piece is circular.

11. The lawn mower according to claim 1, wherein the blade is located between the cutter head and the middle portion.

12. The lawn mower according to claim 1, wherein an end of the middle portion close to a front end of the lawn mower is a first end, an end of the middle portion close to a rear end of the lawn mower is a second end, a first end of the innermost middle portion is closer to the front end of the lawn mower relative to a first end of the outermost middle portion, and a second end of the innermost middle portion is closer to the rear end of the lawn mower relative to a second end of the outermost middle portion.

13. The lawn mower according to claim 1, wherein the body has a first side edge and a second side edge that are oppositely disposed along a first direction, and the first direction intersects with a forward direction of the lawn mower;
the body has a third side edge and a fourth side edge that are oppositely disposed along a second direction, and the second direction is the forward direction of the lawn mower;
in the first direction, a distance between an outer side edge of the cutting mechanism and the first side edge of the body is a first distance, and a distance between the outer side edge of the cutting mechanism and the second side edge of the body is a second distance;
in the second direction, a distance between the outer side edge of the cutting mechanism and the fourth side edge of the body is a fourth distance, and the fourth side edge is a rear outer side edge of the lawn mower; and
the fourth distance is greater than the first distance and greater than the second distance.

14. The lawn mower according to claim 1, wherein the body has a first side edge and a second side edge that are oppositely disposed along a first direction, and the first direction intersects with a forward direction of the lawn mower; and
the protection mechanism further comprises a first protection portion, the first protection portion is disposed between the cutter head and the first side edge and/or between the cutter head and the second side edge.

15. The lawn mower according to claim 14, wherein along the forward direction of the lawn mower, a length of the first protection portion is greater than the length of the middle portion.
